(19) United States
(12) Patent Application Publication
(10) Pub. No.: US 2026/0268497 A1
(43) Pub. Date: Sep. 10, 2026

(54) DUST MONITORING AND CONTROL

(71) Applicants: ABC DUST TECHNOLOGIES CORP., Québec (CA); ABCDUST LTDA, Las Condes (CL)

(72) Inventors: Samuel TOLEDO SUBIRANA, Québec (CA); Rafael TOLEDO SUBIRANA, Québec (CA)

(21) Appl. No.: 19/555,723

(22) Filed: Mar. 3, 2026

(30) Foreign Application Priority Data
Mar. 5, 2025 (CA) 3266869

(51) Int. Cl. G06T 7/11; G01N 15/06; G01W 1/10

(52) U.S. Cl. CPC G06T 7/11; G01N 15/06; G01W 1/10; G06T 2207/20081

(57) ABSTRACT

Method and systems for monitoring and controlling dust emissions are provided. An image and image metadata are acquired, along with meteorological and operational data. The image is used to estimate current particulate matter concentrations using a neural network trained to generate a segmentation mask identifying dust. The predicted concentrations can be provided to a prediction engine implementing a combination of mathematical models with supervised and reinforcement learning to forecast future particulate matter concentrations and implement control actions to maintain dust emissions below an acceptable level.

### CROSS-REFERENCE TO RELATED APPLICATION

This application claims the benefit of, and priority to, Canadian Patent Application No. 3,266,869, filed Mar. 5, 2025, and entitled “Dust Monitoring and Control”, the disclosure of which is hereby incorporated by reference in its entirety.

### TECHNICAL FIELD

The technical field relates to industrial automation, and more specifically to systems and methods for monitoring and automatically controlling dust emissions in an industrial site.

### BACKGROUND

Dust management in industrial settings relies mainly on reactive technologies such as water spraying, nebulization and filtration equipment. Existing technologies have significant limitations, in particular for predicting dust conditions for proactive intervention.

Moreover, existing dust detection technologies, such as photonic sensors, particle counters, gravimetric samplers and LiDAR are costly, limiting their widespread use. The costs make implementation difficult, especially for large sites. These technologies also have limitations in measurement range and precision. As an example, many sensors can be used to survey area sizes of 1 m² up to 300-metre radius zones and measure dust concentrations between 1 and 1,500 mg/m³. Environments such as mining operations site, though, can exhibit dust concentrations of up to 2,000 to 4,000 mg/m³, often exceeding the capabilities of existing sensors. Calibration and exploitation costs associated with these sensors, as well as operational complexities, also hinder their deployment.

Without precise and continuous, real-time data, it is difficult to create and train monitoring algorithms, which limits the efficacy of automated systems. Algorithms require large amounts of data to achieve a suitable performance, and the lack of uninterrupted monitoring compromises the ability to adjust responses with respect to actual on-site conditions.

### SUMMARY

The present disclosure introduces more accessible solutions, capable of providing superior quality data in real time while being more affordable.

In accordance with an aspect, a method for monitoring and controlling dust emissions in a site is provided. The method includes acquiring an image of a zone of the site and image metadata, the image metadata comprising at least one of: a longitude, a latitude, and a timestamp, acquiring and/or estimating from the image using a weather prediction model meteorological data comprising at least one of ultraviolet radiation level, wind speed and/or direction, soil and/or air humidity, soil and/or air temperature, barometric pressure, visibility, sky condition, and precipitation status, acquiring and/or estimating from the image using an operational prediction model operational data comprising at least one of: assets and equipment locations, traffic flow and/or throughput rate, vehicle load and/or speed value, amount of material charge and/or discharge, chute height, type of soil material, type of water truck and/or irrigation measure, and road conditions, estimating current particulate matter data in the zone, comprising concentration of particulate matter, a current concentration range of particulate matter and/or a current activity emission factor of particulate matter in the zone, comprising providing the image as input to a neural network pre-trained to generate a segmentation mask corresponding to the image as output, optionally wherein the neural network is fine-tuned in the zone and/or in the site for the estimation using pairs of dust measurement data and fine-tuning images) and estimating the current particulate matter data based on the segmentation mask, forecasting future particulate matter data in the zone, comprising a future concentration of particulate matter, a future concentration range of particulate matter and/or a future activity emission factor of particulate matter in the zone, based on the current particulate matter data, the meteorological data and the operational data, optionally by aggregating, for each respective parameter of a plurality of parameters selected based on a type of the zone and/or of the site, a quotient of a baseline value of the respective parameter and of a forecast value of the respective parameter, for instance based on a weighted sum, based additionally on a precipitation factor, and/or based on the output of a machine learning model based trained using supervised learning and/or reinforcement learning, and in response to the current concentration of particulate matter and/or the future concentration of particulate matter being above a configurable threshold, causing an alarm and/or implementation of a control action, optionally wherein the forecast is based additionally on the control action.

In accordance with another aspect, a system for monitoring and controlling dust emissions in a site is provided. The system includes an image acquisition device configured to acquire an image of a zone of the site and image metadata, an image processing engine comprising a neural network model trained to accept an image of the zone as input and generate a segmentation mask as output, the processing engine being configured to estimate current particulate matter data in the zone, comprising a current concentration of particulate matter, a current concentration range of particulate matter and/or a current activity emission factor in the zone, based on the segmentation mask, a weather station and/or a weather satellite configured to measure meteorological data, and/or a weather prediction model configured to predict the meteorological data based on the image, an operational monitoring system configured to acquire operational data and/or an operational prediction model configured to predict the operational data based on the image, and a prediction engine configured to forecast future particulate matter data, comprising a future concentration of particulate matter, a future concentration range of particulate matter and/or a future activity emission factor in the zone, based on the current particulate matter data, the meteorological data and the operational data.

In accordance with a further aspect, a method for monitoring and controlling dust emissions in a site. The method includes acquiring an image of a zone of the site and image metadata by an image acquisition device, estimating, by a neural network model trained to accept an image of the zone as input and generate a segmentation mask as output, current particulate matter data in the zone, comprising a current concentration of particulate matter, a current concentration range of particulate matter and/or a current activity emission factor in the zone, based on the segmentation mask, measuring or predicting based on the image meteorological data, acquiring or predicting based on the image operational data, and forecasting future particulate matter data, comprising a future concentration of particulate matter, a future concentration range of particulate matter and/or a future activity emission factor in the zone, based on the current particulate matter data, the meteorological data and the operational data.

In accordance with yet another aspect, a non-transitory computer-readable medium having instructions stored thereon is provided. The instructions, when executed by one or more processors, cause the one or more processors to acquire an image of a zone of the site and image metadata via an image acquisition device, estimate, by a neural network model trained to accept an image of the zone as input and generate a segmentation mask as output, current particulate matter data in the zone, comprising a current concentration of particulate matter, a current concentration range of particulate matter and/or a current activity emission factor in the zone, based on the segmentation mask, measure or predict based on the image meteorological data, acquire or predicting based on the image operational data, and forecast future particulate matter data, comprising a future concentration of particulate matter, a future concentration range of particulate matter and/or a future activity emission factor in the zone, based on the current particulate matter data, the meteorological data and the operational data.

In accordance with yet another aspect, a system for monitoring and controlling dust emissions in a site is provided. The system includes an image acquisition device configured to acquire an image of a zone of the site and image metadata, an image processing engine including a neural network model trained to accept an image of the zone as input and generate a segmentation mask as output, the processing engine being configured to estimate current particulate matter data in the zone, including a current concentration of particulate matter, a current concentration range of particulate matter and/or a current activity emission factor in the zone, based on the segmentation mask, a weather station and/or a weather satellite configured to measure meteorological data, and/or a weather prediction model configured to predict the meteorological data based on the image, an operational monitoring system configured to acquire operational data and/or an operational prediction model configured to predict the operational data based on the image, and a prediction engine configured to forecast future particulate matter data, including a future concentration of particulate matter, a future concentration range of particulate matter and/or a future activity emission factor in the zone, based on the current particulate matter data, the meteorological data and the operational data.

In some embodiments, the image acquisition device includes one or more surveillance cameras, one or more stereo cameras and/or one or more thermal cameras installed in the site.

In some embodiments, the neural network is a convolutional neural network trained using a dataset including annotated images, each annotated image including a test image and a ground truth segmentation mask.

In some embodiments, the neural network is fine-tuned for the zone and/or for the site using a fine-tuning system including at least one air quality monitoring device installed in a vicinity of the image acquisition device and configured to acquire dust measurement data and/or at least one mobile dust monitor each paired with at least one position sensor, and a fine-tuning module configured to compare particulate matter data estimations generated by the image processing engine based on fine-tuning images acquired by the image acquisition device and the dust measurement data and to optimize parameters of the neural network based on the comparison.

In some embodiments, the air quality monitoring system includes at least a gravimetric sampler, a laser particulate counter and/or a LiDAR system configured to measure different sizes of particulate matter, silica levels and/or other airborne pollutant levels.

In some embodiments, the meteorological data include at least one of ultraviolet radiation level, wind speed and/or direction, soil and/or air humidity, soil and/or air temperature, barometric pressure, visibility, sky condition, and precipitation status.

In some embodiments, the operational data include at least one of assets and equipment locations, traffic flow and/or throughput rate, vehicle load and/or speed value, amount of material charge and/or discharge, chute height, type of soil material, type of water truck and/or irrigation measure, and road conditions.

In some embodiments, the prediction engine is configured to forecast the future particulate matter data by aggregating, for each respective parameter of a plurality of parameters selected based on a type of the zone and/or of the site, a quotient of a baseline value of the respective parameter and of a forecast value of the respective parameter.

In some embodiments, the aggregation is based on a weighted sum, and/or on minimum values and/or maximum values.

In some embodiments, the prediction engine is configured to forecast the future particulate matter data based additionally on a precipitation factor.

In some embodiments, the prediction engine is configured to forecast the future particulate matter data based on a trained machine learning model.

In some embodiments, the prediction engine is configured to cause an implementation of a control action, and forecast the future particulate matter data based additionally on the control action.

In some embodiments, the system further includes a dust reduction efficiency module configured to compute efficiency data including efficacy values of the control action based on a baseline for dust concentrations and the current particulate matter data.

In some embodiments, the efficiency data further include efficiency values of the control action based on the efficacy values and on a resource usage of the control action.

In some embodiments, the prediction engine includes a machine learning model trained using the efficiency data to select the control action.

In some embodiments, the system further includes a sensor system including at least one of a vibration sensor, a pressure sensor and a noise sensor, configured to forecast dust control equipment and/or operational equipment maintenance needs.

In some embodiments, the system further includes additional image acquisition devices configured to acquire images of additional zones of the site and additional image metadata, wherein the image processing engine is further configured to estimate additional particulate matter data of the site, including additional current concentrations, additional current concentration ranges and/or additional current activity emission factors of particulate matter in the additional zones, and the prediction engine is further configured to forecast additional future particulate matter data of the site, including additional future concentrations, additional future concentration ranges and/or additional future activity emission factors of particulate matter in the additional zones.

In some embodiments, the prediction engine is further configured to optimize at least one watering route, a dry fog system activation and/or intensification, at least one dust collector activation and/or at least one water cannon activation.

In some embodiments, the system further includes a graphical user interface configured to display at least one of a bidimensional or tridimensional map of the site indicating the current particulate matter data of the zone, the additional particulate matter data of the site, the future particulate matter data of the zone, and/or the additional future particulate matter data of the site, real-time data regarding at least one zone of interest of the zone and the additional zones, the real-time data including at least one of real-time current particulate matter data in the zone of interest, real-time future particulate matter data in the zone of interest, real-time meteorological data, real-time operational data, and real-time sensor data, historical data regarding the zone of interest, the historical data including at least one of historical current particulate matter data in the zone of interest, historical future particulate matter data in the zone of interest, historical meteorological data, and historical operational data, projected future data regarding the zone of interest, the projected future data including at least one of projected future particulate matter data in the zone of interest, projected future meteorological data, and projected future operational data, an alarm regarding the zone of interest, in response to the real-time current particulate matter data in the zone of interest and/or the projected future particulate matter data in the zone of interest being above a configurable threshold, a quantity of water and/or dust suppression products consumed in the site, and programmed dust control activities.

In some embodiments, at least the image acquisition device is included in a plurality of industrial Internet of Things devices, further including an edge subsystem operatively connected to the industrial Internet of Things devices, the edge subsystem including at least one processor configured for running at least one of the image processing engine and the prediction engine based on data received from the industrial Internet of Things devices, and a cloud subsystem communicatively linked to the edge subsystem, the cloud subsystem being configured to train the models, wherein the trained models are transmitted to the edge subsystem for fine-tuning and/or execution.

In some embodiments, the industrial Internet of Things devices and the edge subsystem are communicatively connected via a mesh network, the mesh network enabling decentralized communication between the industrial Internet of Things devices and the edge subsystem.

In yet a further aspect, a method for monitoring and controlling dust emissions in a site is provided. The method includes acquiring an image of a zone of the site and image metadata by an image acquisition device, estimating, by a neural network model trained to accept an image of the zone as input and generate a segmentation mask as output, current particulate matter data in the zone, including a current concentration of particulate matter, a current concentration range of particulate matter and/or a current activity emission factor in the zone, based on the segmentation mask, measuring or predicting based on the image meteorological data, acquiring or predicting based on the image operational data, and forecasting future particulate matter data, including a future concentration of particulate matter, a future concentration range of particulate matter and/or a future activity emission factor in the zone, based on the current particulate matter data, the meteorological data and the operational data.

In some embodiments, the image acquisition device includes one or more surveillance cameras, one or more stereo cameras and/or one or more thermal cameras installed in the site.

In some embodiments, the neural network is a convolutional neural network trained using a dataset including annotated images, each annotated image including a test image and a ground truth segmentation mask.

In some embodiments, the neural network is fine-tuned for the zone and/or for the site, the fine-tuning including acquiring dust measurement data by at least one air quality monitoring device installed in a vicinity of the image acquisition device and/or at least one mobile dust monitor each paired with at least one position sensor, and comparing particulate matter data estimations generated by the image processing engine based on fine-tuning images acquired by the image acquisition device and the dust measurement data and to optimize parameters of the neural network based on the comparison.

In some embodiments, the method further includes measuring different sizes of particulate matter, silica levels and/or other airborne pollutant levels by at least a gravimetric sampler, a laser particulate counter and/or a LiDAR system.

In some embodiments, the meteorological data include at least one of ultraviolet radiation level, wind speed and/or direction, soil and/or air humidity, soil and/or air temperature, barometric pressure, visibility, sky condition, and precipitation status.

In some embodiments, the operational data include at least one of assets and equipment locations, traffic flow and/or throughput rate, vehicle load and/or speed value, amount of material charge and/or discharge, chute height, type of soil material, type of water truck and/or irrigation measure, and road conditions.

In some embodiments, forecasting the future particulate matter data includes aggregating, for each respective parameter of a plurality of parameters selected based on a type of the zone and/or of the site, a quotient of a baseline value of the respective parameter and of a forecast value of the respective parameter.

In some embodiments, the aggregation is based on a weighted sum, and/or on minimum values and/or maximum values.

In some embodiments, forecasting the future particulate matter data is based additionally on a precipitation factor.

In some embodiments, wherein forecasting the future particulate matter data is based on a trained machine learning model.

In some embodiments, the method further includes implementing a control action, wherein forecasting the future particulate matter data is based additionally on the control action.

In some embodiments, the method further includes computing efficiency data including efficacy values of the control action based on a baseline for dust concentrations and the current particulate matter data.

In some embodiments, the efficiency data further include efficiency values of the control action based on the efficacy values and on a resource usage of the control action.

In some embodiments, the method further includes using a machine learning model trained using the efficiency data to select the control action.

In some embodiments, the method further includes forecasting dust control equipment and/or operational equipment maintenance needs based on readings from a sensor system including at least one of a vibration sensor, a pressure sensor and a noise sensor.

In some embodiments, the method further includes acquiring images of additional zones of the site and additional image metadata by additional image acquisition devices, estimating additional particulate matter data of the site, including additional current concentrations, additional current concentration ranges and/or additional current activity emission factors of particulate matter in the additional zones, and forecasting additional future particulate matter data of the site, including additional future concentrations, additional future concentration ranges and/or additional future activity emission factors of particulate matter in the additional zones.

In some embodiments, the method further includes optimizing at least one watering route, a dry fog system activation and/or intensification, at least one dust collector activation and/or at least one water cannon activation.

In some embodiments, the method further includes displaying on a graphical user interface at least one of a bidimensional or tridimensional map of the site indicating the current particulate matter data of the zone, the additional particulate matter data of the site, the future particulate matter data of the zone, and/or the additional future particulate matter data of the site, real-time data regarding at least one zone of interest of the zone and the additional zones, the real-time data including at least one of real-time current particulate matter data in the zone of interest, real-time future particulate matter data in the zone of interest, real-time meteorological data, real-time operational data, and real-time sensor data, historical data regarding the zone of interest, the historical data including at least one of historical current particulate matter data in the zone of interest, historical future particulate matter data in the zone of interest, historical meteorological data, and historical operational data, projected future data regarding the zone of interest, the projected future data including at least one of projected future particulate matter data in the zone of interest, projected future meteorological data, and projected future operational data, an alarm regarding the zone of interest, in response to the real-time current particulate matter data in the zone of interest and/or the projected future particulate matter data in the zone of interest being above a configurable threshold, a quantity of water and/or dust suppression products consumed in the site, and programmed dust control activities.

In some embodiments, at least the image acquisition device is included in a plurality of industrial Internet of Things devices, the method further including performing at least one of the estimating the current particulate matter data in the zone and forecasting the future particulate matter data by an edge subsystem operatively connected to the industrial Internet of Things devices based on data received from the industrial Internet of Things devices, and training the models by a cloud subsystem communicatively linked to the edge subsystem, wherein the trained models are transmitted to the edge subsystem for fine-tuning and/or execution.

In some embodiments, the industrial Internet of Things devices and the edge subsystem are communicatively connected via a mesh network, the mesh network enabling decentralized communication between the industrial Internet of Things devices and the edge subsystem.

In accordance with yet another aspect, a non-transitory computer-readable medium having instructions stored thereon is provided. The instructions, when executed by one or more processors, cause the one or more processors to acquire an image of a zone of the site and image metadata via an image acquisition device, estimate, by a neural network model trained to accept an image of the zone as input and generate a segmentation mask as output, current particulate matter data in the zone, including a current concentration of particulate matter, a current concentration range of particulate matter and/or a current activity emission factor in the zone, based on the segmentation mask, measure or predict based on the image meteorological data, acquire or predicting based on the image operational data, and forecast future particulate matter data, including a future concentration of particulate matter, a future concentration range of particulate matter and/or a future activity emission factor in the zone, based on the current particulate matter data, the meteorological data and the operational data.

In some embodiments, the image acquisition device includes one or more surveillance cameras, one or more stereo cameras and/or one or more thermal cameras installed in the site.

In some embodiments, the neural network is a convolutional neural network trained using a dataset including annotated images, each annotated image including a test image and a ground truth segmentation mask.

In some embodiments, the neural network is fine-tuned for the zone and/or for the site, the fine-tuning including acquiring dust measurement data via at least one air quality monitoring device installed in a vicinity of the image acquisition device and/or at least one mobile dust monitor each paired with at least one position sensor, and comparing particulate matter data estimations generated by the image processing engine based on fine-tuning images acquired by the image acquisition device and the dust measurement data and to optimize parameters of the neural network based on the comparison.

In some embodiments, the air quality monitoring system includes at least a gravimetric sampler, a laser particulate counter and/or a LiDAR system configured to measure different sizes of particulate matter, silica levels and/or other airborne pollutant levels.

In some embodiments, the meteorological data include at least one of ultraviolet radiation level, wind speed and/or direction, soil and/or air humidity, soil and/or air temperature, barometric pressure, visibility, sky condition, and precipitation status.

In some embodiments, the operational data include at least one of assets and equipment locations, traffic flow and/or throughput rate, vehicle load and/or speed value, amount of material charge and/or discharge, chute height, type of soil material, type of water truck and/or irrigation measure, and road conditions.

In some embodiments, forecasting the future particulate matter data includes aggregating, for each respective parameter of a plurality of parameters selected based on a type of the zone and/or of the site, a quotient of a baseline value of the respective parameter and of a forecast value of the respective parameter.

In some embodiments, the aggregation is based on a weighted sum, and/or on minimum values and/or maximum values.

In some embodiments, forecasting the future particulate matter data is based additionally on a precipitation factor.

In some embodiments, forecasting the future particulate matter data is based on a trained machine learning model.

In some embodiments, the instructions further cause the one or more processors to implement a control action, wherein forecasting the future particulate matter data is based additionally on the control action.

In some embodiments, the instructions further cause the one or more processors to compute efficiency data including efficacy values of the control action based on a baseline for dust concentrations and the current particulate matter data.

In some embodiments, the efficiency data further include efficiency values of the control action based on the efficacy values and on a resource usage of the control action.

In some embodiments, the instructions further cause the one or more processors to use a machine learning model trained using the efficiency data to select the control action.

In some embodiments, the instructions further cause the one or more processors to forecast dust control equipment and/or operational equipment maintenance needs based on readings from a sensor system including at least one of a vibration sensor, a pressure sensor and a noise sensor.

In some embodiments, the instructions further cause the one or more processors to acquire images of additional zones of the site and additional image metadata by additional image acquisition devices, estimate additional particulate matter data of the site, including additional current concentrations, additional current concentration ranges and/or additional current activity emission factors of particulate matter in the additional zones, and forecast additional future particulate matter data of the site, including additional future concentrations, additional future concentration ranges and/or additional future activity emission factors of particulate matter in the additional zones.

In some embodiments, the instructions further cause the one or more processors to optimize at least one watering route, a dry fog system activation and/or intensification, at least one dust collector activation and/or at least one water cannon activation.

In some embodiments, the instructions further cause the one or more processors to display on a graphical user interface at least one of a bidimensional or tridimensional map of the site indicating the current particulate matter data of the zone, the additional particulate matter data of the site, the future particulate matter data of the zone, and/or the additional future particulate matter data of the site, real-time data regarding at least one zone of interest of the zone and the additional zones, the real-time data including at least one of real-time current particulate matter data in the zone of interest, real-time future particulate matter data in the zone of interest, real-time meteorological data, real-time operational data, and real-time sensor data, historical data regarding the zone of interest, the historical data including at least one of historical current particulate matter data in the zone of interest, historical future particulate matter data in the zone of interest, historical meteorological data, and historical operational data, projected future data regarding the zone of interest, the projected future data including at least one of projected future particulate matter data in the zone of interest, projected future meteorological data, and projected future operational data, an alarm regarding the zone of interest, in response to the real-time current particulate matter data in the zone of interest and/or the projected future particulate matter data in the zone of interest being above a configurable threshold, a quantity of water and/or dust suppression products consumed in the site, and programmed dust control activities.

In some embodiments, at least the image acquisition device is included in a plurality of industrial Internet of Things devices, and the instructions further cause the one or more processors to have at least one of the estimating the current particulate matter data in the zone and forecasting the future particulate matter data performed via an edge subsystem operatively connected to the industrial Internet of Things devices based on data received from the industrial Internet of Things devices, and have training the models performed via a cloud subsystem communicatively linked to the edge subsystem, wherein the trained models are transmitted to the edge subsystem for fine-tuning and/or execution.

In some embodiments, the industrial Internet of Things devices and the edge subsystem are communicatively connected via a mesh network, the mesh network enabling decentralized communication between the industrial Internet of Things devices and the edge subsystem.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1A is a schematic of a system for monitoring and controlling dust emissions, in accordance with an embodiment.

FIG. 1B is an illustration of a digital image, in accordance with an example and an embodiment.

FIG. 1C is an illustration of a segmented digital image, in accordance with the example of FIG. 1B and an embodiment.

FIG. 2 is a flowchart of a method for monitoring and controlling dust emissions, in accordance with an embodiment.

FIG. 3 is a schematic of a system for fine-tuning an image processing engine, in accordance with an embodiment.

FIG. 4 is a flowchart of a method for fine-tuning an image processing engine, in accordance with an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

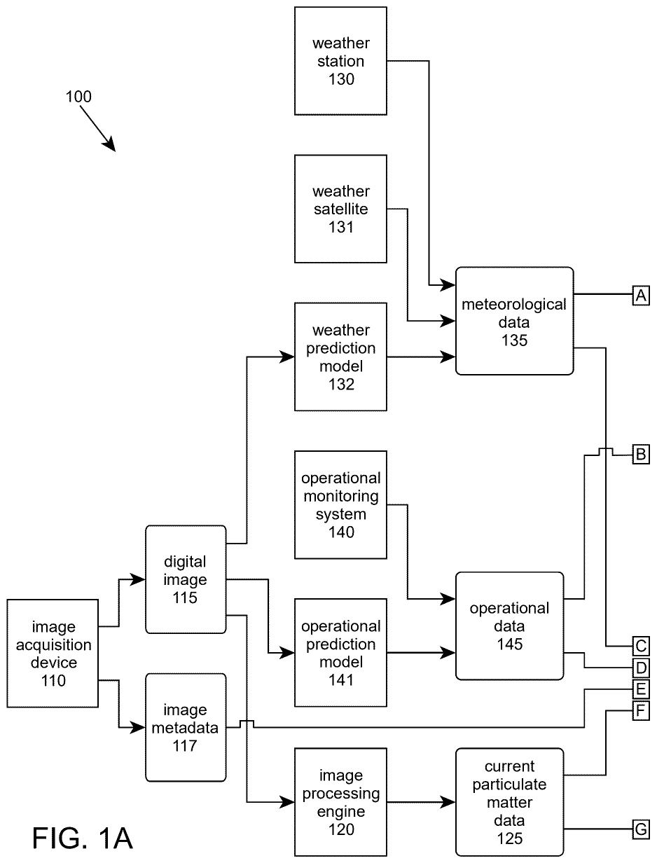

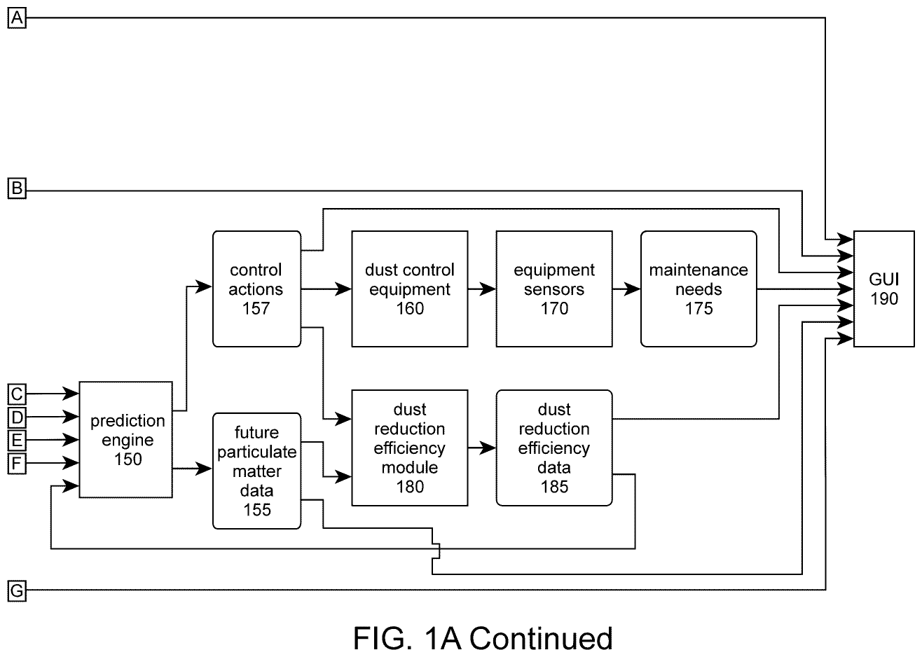

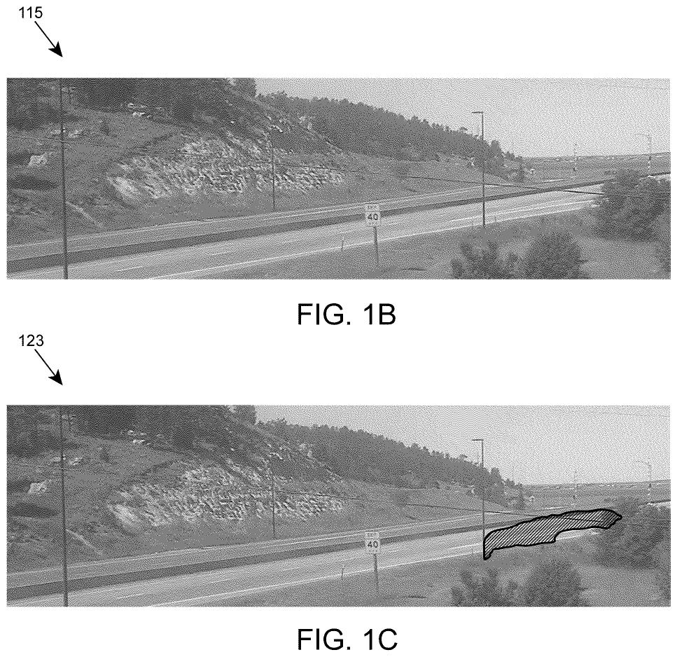

With reference to FIGS. 1A to 1C, an exemplary system 100 for controlling dust emissions in a site is shown. The site can correspond to any site or facility, such as industrial sites, where dust emissions need to be monitored and/or controlled, including for instance mining operation, cement plants, construction sites, steel mills, processing plants, waste treatment facilities or ports and shipping terminals.

Broadly described, the system 100 includes at least one image acquisition device 110 which captures digital images 115 that are processed by an image processing engine 120 to extract current particulate matter (PM) data 125, i.e., data contemporary with the moment at which the image 115 was acquired. This data is suitable for ingestion by a prediction engine 150 that can perform forecasts 155 and/or take control actions 157.

The system 100 includes at least one image acquisition device 110. Each image acquisition device 110 includes at least one imaging sensor, such as one or more cameras, including for instance monocular and/or stereo, visible light, RGB, monochrome, hyperspectral, infrared, ultraviolet and/or thermal cameras. In some embodiments, the system 100 can leverage existing infrastructure in the site by having an image acquisition device 110 include pre-existing imaging sensors, for instance one or more surveillance cameras. Each image acquisition device 110 can be located in one or more positions to survey a specific zone of the site. As examples, if the site is a mining site, a zone could correspond to a portion of a hauling road, to a crusher, a tails storing facility and/or a reception area. It can be appreciated that an image acquisition device 110 can include one or more imaging sensors located in a single place to acquire images with a specific point of view on the surveyed zone, or can alternatively include a plurality of imaging sensors located at different positions to acquire images with multiple different points of view of the zone.

An image acquisition device 110 can be configured to acquire or capture a digital image 115 of the zone of the time continually, at given times, at a given interval, from time to time, and/or when it receives an indication to do so from another component of system 100 or from a user of the system 100. Whenever the image acquisition device acquires an image 115, it can also acquire corresponding metadata 117. The metadata 117 can for instance include a unique identifier of the image acquisition device 110 and/or the imaging sensor that acquired the image 115, acquisition parameters such as resolution, shutter speed, aperture, sensitivity and/or focal length, indications of the area where the imaging device is located including for instance an identifier of the zone, a longitude and/or a latitude, and an indication of the date and/or time at which the image 115 was captured, for instance a timestamp such as an ISO 8601 timestamp and/or a Unix timestamp.

The system 100 includes an image processing engine 120 to process digital images 115 acquired by an image acquisition device 110. The image processing engine 120 is configured to estimate current particulate matter data 125 based on the digital image 115. PM data 125 can include any data providing an absolute or relative indication of levels of dust or PM observable in the digital image 115. This includes for instance a current concentration of PM observable in the digital image, a current concentration range of PM observable in the digital image, e.g., using a suitable number of predetermined concentration intervals, and/or a current activity emission factor of PM, i.e., a concentration, concentration range, quantity or proportion of dust made airborne due to an industrial activity such as tires rolling on an unsealed road or a crusher operating. PM can correspond to one or more of a number of given types such as coarse particulate matter, including for instance particles with a diameter of 10 μm or less (PM10), fine particulate matter, including for instance particles with a diameter of 2.5 μm or less (PM2.5), ultrafine particles, including for instance particles with a diameter of 1 μm or less, inhalable particles, black carbon, silica and/or other airborne pollutants. In some embodiments, particulate matter more specifically corresponds to PM10.

Image processing engine 120 can for instance include a machine learning model trained to accept a digital image 115 as input and generate particulate matter data 125 as output. As an example, the machine learning model can be trained to accept a tensor corresponding to the digital image 115 of a given pixel size as input and generate a PM mask of the same pixel size, indicating for instance whether a relatively high quantity of PM or a concentration above a relative or predetermined threshold is observable in each pixel. As an example illustration, FIG. 1B shows a digital image 115 captured by an image acquisition device 110, and FIG. 1C shows a PM mask 123 computed by the image processing engine 120 superimposed upon the image 115. In some embodiments, the machine learning model can be trained to alternatively or additionally generate a PM map, indicating for instance a level of PM observable in each pixel and/or visible dust concentration and percentage indicator as a percentage and intensity indicator of the image frame or frame subdivision.

The trained machine learning model can correspond to any suitable type of regressive model that contains layers to process image inputs, such as a neural network model. In some embodiments, the model corresponds to a model of a convolutional neural network (CNN). A digital image 115 can be converted to a tensor, e.g., a bidimensional or a tridimensional tensor of a suitable size. As examples only, tensor sizes of 256×256×1 or 512×512×1 can be used for a bidimensional grayscale image, 256×256×2 or 512×512×2 for a grayscale image with the depth of each pixel provided or for a stereo grayscale image, 256×256×3 or 512×512×3 for a bidimensional colour image using RGB, 256×256×4 or 512×512×4 for a colour image with the depth of each pixel provided, or 256×256×6 or 512×512×6 for a stereo colour image. In some embodiments, the output of the CNN will correspond to a tensor with the same size as the input tensor in the first dimensions and a size of one in the third dimension, i.e., a matrix. As an example, the output can correspond to a 256×256×1 or 512×512×1 tensor, or to a 256×256 or 512×512 matrix. It can be appreciated that these sizes are provided as examples only, and that any other suitable size can be used. For instance, smaller sizes can be used for faster processing time or larger sizes can be used for increased accuracy. In some embodiments, the first two dimensions of the input and output tensors are different.

The CNN can comprise an encoder-decoder architecture, where the input tensor corresponding to the image 115 serves as the input to the first convolutional layer in the encoder. Each layer in the encoder is configured to apply filters or kernels of a suitable size, for instance 3×3, with appropriate padding and stride, for instance 0 and 1, followed by an activation function such as the rectified linear unit (ReLU) function. The encoder captures the relevant features from the image. In some embodiments, a batch normalization layer can be applied between any two convolutional layers. In some embodiments, pooling layers can be applied in the encoder to reduce the spatial dimensions, implementing a suitable pooling function, such as max pooling.

The output of the last convolutional layer of the encoder can be provided as input to the first layer of the decoder. In some embodiments, the output of the last convolutional layer of the encoder can be provided as input to a fully connected block, and the output of the fully connected block can be provided as input to the first layer of the decoder. The decoder portion of the CNN is responsible for upsampling the feature maps, using techniques like transposed convolution or upsampling layers. These layers progressively recover spatial resolution, enabling precise pixel-level predictions. The output of the final convolutional layer in the decoder can produce a pixel-wise mask indicating whether each pixel has a high dust level or not or a pixel-wise map indicating the dust level of each pixel. The output of the last layer of the decoder can thus correspond to a mask or map with the same spatial dimensions as the input image, where each pixel is assigned a label, such as, as an example, “high dust level” or “no high dust level”, or, as another example, a real number between 0 and 1, where 0 means “no dust” or “lowest level of dust” and 1 means “only dust visible” or “highest level of dust”.

In some embodiments, the CNN can have a U-Net architecture and use skip connections from the encoder to the corresponding layers in the decoder to help retain high-resolution features. It can be appreciated that different neural network architectures are suitable to generating PM data 125. As an example, different CNN architectures such as Attention U-Nets, Fully Convolutional Networks, SegNets and DenseNets can be used to generate PM data 125. In some embodiments, an ensemble model including one or more of the types of models described above and/or alternative types of models is used to generate PM data 125.

In some embodiments, the output of the machine learning model is not directly used as PM data 125. Rather, the image processing engine 120 can be configured to use the output of the machine learning model to infer the PM data 125. As an example, when the output is a dust mask, the image processing engine 120 can be configured to compute a percentage of the pixels labelled as having a high level of dust and provide this percentage as PM data 125. In some embodiments, one or more value corresponding more closely to a measurement of the PM level, such as a concentration or a concentration range of PM is inferred from the computed percentage. In some embodiments, the image processing engine 120 is classified before the system 100 is used in production as explained further below in order to obtain accurate PM data based on specificities of the site and/or zone.

The system 100 can be configured to acquire meteorological data 135. The system 100 can for instance include at least one weather station 130, such as for instance a Davis™ and/or a Lufft™ weather station, or be in communication with at least one weather satellite 131 and/or a weather information service such as the Tomorrow.io™ weather API. In some embodiments, the system 100 includes at least one meteorological prediction model 132 configured to process the digital image 115 and predict meteorological data 135 from it, for instance off-the-shelf, pre-trained models, in addition or as a replacement for other equipment such as weather stations 130 or satellites 131. As examples, meteorological data 135 can include data related to weather conditions in the site or in a zone of the site, including for instance ultraviolet (UV) radiation level, wind speed and/or direction, soil and/or air humidity, e.g., relative humidity, absolute humidity, specific humidity and/or dew point, soil and/or air temperature, e.g., dry bulb and/or wet bulb temperatures, barometric pressure, visibility, sky condition, e.g., cloud cover, cloud type, cloud amount, cloud height and/or sunshine, and/or precipitation status, e.g., rain, snow, hail, fog and/or mist. In some embodiments, meteorological data 135 includes forecasted meteorological conditions.

The system 100 can be configured to acquire operational data 145. The system 100 can for instance include at least one operational monitoring system 140, including for instance data infrastructure systems such as OISoft™ PI System™, a fleet management system such as Modular Mining™ DISPATCH™ a telematics system, a geographical information system, a real-time location system, a weight monitoring system and/or a driver behaviour monitoring system. In some embodiments, the system 100 includes at least one operational prediction model 141 configured to process the digital image 115 and predict operational data 145 from it, for instance off-the-shelf, pre-trained models, in addition or as a replacement for other equipment such as operational monitoring system 141. As examples, operational data 145 can include data related to industrial operations in the site or in a zone of the site, including for instance assets and equipment locations, traffic flow and/or throughput rate, vehicle load and/or speed value, amount of material charge and/or discharge, chute height type of soil material, type of water truck and/or irrigation measure and/or road conditions. In some embodiments, operational data 145 includes forecasted operational conditions.

The system 100 includes a prediction engine 150 to process the available data, including image metadata 117 of image 115, current particulate matter data 125 measured from image 115, meteorological data 135 and/or operational data 145. In some embodiments, the prediction engine 150 is configured to process a larger available of data acquired over a defined timeframe, for instance data acquired over the last 10 minutes, or over the last hour, or over the last day. As an example, PM data 125 can be provided as a time series of PM data that were current at the different times at which digital images 115 were acquired. The prediction engine 150 is configured to process the data in order to forecast future particulate matter data 155 and/or to implement control actions 157 to keep PM levels within predetermined acceptable ranges. The prediction engine 150 can leverage a number of models of different types to process data for different functions. As an example, the prediction engine can include a mathematical model to forecast future PM data 155 and a reinforcement learning (RL) model to select and parametrize control actions 157.

In some embodiments, the prediction engine 150 includes a mathematical model to forecast future PM data 155, including for instance a future concentration of PM observable in the digital image, a future concentration range of PM and/or a future activity emission factor of PM. The mathematical model can for instance rely on a number of parameters that are part of the current PM data 125, the meteorological data 135 and the operational data 145, and baseline values for some or all of the parameters. Parameters typically include a current and/or a past concentration, concentration range and/or emission factor for at least one type of PM, e.g., PM10, for instance measured in mg/m³. In some embodiments, and for certain types of zones, parameters can include a current and/or a past concentration, concentration range and/or emission factor for at least one type of PM in a different, neighbouring zone. Parameters can further include, as examples, transit, corresponding for instance to a traffic flow and/or a through put, for instance measured in vehicle passes per hour, weight, corresponding for instance to an average vehicle load, for instance measured in tons, speed, corresponding for instance to an average vehicle speed, for instance measured in km/h, the ultraviolet radiation level, for instance measured on the Global Solar UV Index described for instance in World Health Organization, Global Solar UV Index: A Practical Guide (2002), wind speed, for instance measured in m/s, soil moisture, for instance measured as a percentage of volumetric or gravimetric water content, weight processing rate, for instance measured in t/h or t/d, a relative humidity, for instance measured as a percentage of air saturation by water vapour, percentage of a dry fog system operation, air or barometric pressure, e.g., at ground level, for instance measured in hPa or inHg, material moisture, for instance measured as a percentage of volumetric or gravimetric water content, and/or average number of workers on site.

In some embodiments, the set of parameters is selected based on the type of site and/or zone for which the forecast is made. As examples only, in a mining site, a zone corresponding to a portion of a haul road and/or to tails storage can rely on PM10, transit, average weight, average speed, UV levels, wind speed and/or soil moisture, a zone including a crusher can rely on PM10, weight processing rate, percentage of a dry fog system operation, barometric pressure at ground level, wind speed and/or material moisture, and a zone corresponding to a reception area can rely on local PM10, PM10 in neighbouring crusher zones, PM10 in neighbouring haul road zones, number of workers on site, air pressure, wind speed and/or weight processing rate. As examples only, in a mining site, suitable baselines can be approximately 12 mg/m³ PM10 concentration in a zone corresponding to a portion of a haul road or including a crusher, 5 mg/cm³ for a zone corresponding to a reception area or 1 mg/cm³ for a zone corresponding to a tails storage, 1 pass per hour on a haul road and 2 passes per hour in a tails storage zone, 30 t average weight, 20 km/h average speed, 7 UV levels, 3.5 m/s wind speed, 8% soil moisture on a haul road and 6% soil moisture in a tails storage zone, 4,500 t/h processed in a crusher and 60,000 t/h processed in a reception area, 25% relative humidity, 95% dry fog system operation, 25 inHg (ca. 847 hPa) air or barometric pressure at ground level in most zones except 20 inHg (ca. 677 hPa) in a reception area, 30 workers on site, and a 1% material moisture.

The mathematical can forecast future PM data 155 by aggregating for each selected parameter a quotient of its measured or estimated value and its baseline value, for instance b/v where b is the baseline value and v is the parameter measured or estimated value, or

$${( \frac{b}{v} )}^{- 1} = \frac{v}{b}$$

depending on whether the parameter is positively or negatively correlated to dust level. The quotients can be aggregated, for instance based on a sum, e.g., a weighted sum. In some embodiments, the aggregation can be based on minimum and/or maximum values or on a central measure such as a means or a median. A factor is applied to each quotient before aggregation, for instance a baseline value of the parameter to be forecasted, e.g., PM10. A precipitation factor can be applied to the result to account for precipitations or maintenance at the site. As an example, the precipitation factor can have a value of 0.05 when there is rain or maintenance, representing a 95% reduction of dust levels. A control factor and a dilution factor can be applied to the result to account for control actions 157. The control factor can correspond to a reduction of the dust concentration after the application of a dust control, for example the application of additives. Each specific control action and each type of site and/or zone can be associated with a specific control factor, as further detailed below. The dilution factor can decrease the effect of the control factor, accounting for instance for time, traffic and/or a material processing rate, as further detailed below. In some embodiments, when multiple dilution factors are applicable due to a combination of situations, only the situation that causes the lowest dilution factor, i.e., causing the biggest reduction, is accounted for. The dilution factor can be normalized with a fixed variable that represents, e.g., the time or passes until the control factor is ineffective. As an example, if the zone corresponds to a portion of a haul road, the fixed time variable corresponds to 24 hours, which means that after 12 hours, the dilution factor would be (24−12)÷24=50%. The fixed variables depend on the types of site and/or zones as well as the specific control action and are further detailed below. In some embodiments, a forecasted dust concentration can be computed by applying the equation

$$p \cdot \sum [ {b}_{PM 10} \cdot w {( \frac{b}{v} )}^{i} ] \cdot ( 1 - c \cdot d )$$

where p is the precipitation factor, w is the weight applicable to each parameter, i is a correlation direction exponent, with 1 indicating a positive correlation and −1 indicating a negative correlation, c is the control factor and d is the dilution factor.

Suitable weights for the aggregation of parameters can be selected based on the type of site and/or zone for which the forecast is made. As examples only, in a mining site, a zone corresponding to a portion of a haul road can assign weights of approximately 50 to PM10, 3 to transit, 1 to average weight, 15 to average speed, 1 to UV level, 35 to wind speed and 1 to soil moisture, a zone corresponding to tails storage can assign weights of approximately 15 to PM10, 3 to transit, 1 to average weight, 4 to average speed, 1 to UV level, 1 to wind speed and 10 to soil moisture, a zone including a crusher can assign weights of approximately 10 to PM10, 3 to weight processing rate, 4 to percentage of a dry fog system operation, 1 to barometric pressure at ground level, 1 to wind speed and 2 to material moisture, and a zone corresponding to a reception area can assign weights of approximately 16 local PM10, 1 to PM10 in neighbouring crusher zones, 1 to PM10 in neighbouring haul road zones, 1 to number of workers on site, 5 to air pressure, 1 to wind speed and 3 to weight processing rate.

In some embodiments, when determining a PM concentration in a zone of interest depends on PM concentrations in different, neighbouring zones, the wind direction is taken into consideration. As an example only, in a neighbouring zone, if the wind is flowing in a direction approximately ±30° towards the zone of interest, the PM concentration of the neighbouring zone can be used with a factor of 1, but in other cases, the PM concentration can be used with a suitably reduced factor, e.g., 0.9.

In some embodiments, the prediction engine 150 employs a trained machine learning model to forecast future PM data 155, alternatively or in addition to using a mathematical model. As examples only, the prediction engine 150 can implement linear regression, decision tree regression, random forest regression and/or XGBoost, using data 125, 135, 145 as features. As further examples, the prediction engine 150 can implement a regression neural network, such as a multi-layer perceptron (MLP). A subset of the data can be selected to be used as features, for instance using filter methods, e.g., by applying statistical tests such as χ² to the available features, and/or using wrapper methods, e.g., by using a machine learning algorithm to evaluate feature subsets.

In some embodiments, the prediction engine 150 includes a rule-based system and/or a machine-learning system to implement control actions 157. Control actions 157 are aimed at reducing particulate matter concentrations or emissions, and can depend on the type of site and/or zone. As examples only, in a mining site, in particular in zones including haul roads or tails storage, possible control actions can include watering surfaces, applying bischofite, for instance by watering surfaces with a bischofite solution and/or using Dust Mitigation System-Dry Suppression (DMS-DS) methods such as DMS-DS Twice, which can for instance include first applying a coarse mist to settle larger particles and create an initial binding layer, then applying a finer mist to capture and settle smaller particles. As further examples, in a zone including a crusher, possible control actions can include performing maintenance, fogging, e.g., with misting cannons and/or through nozzles installed on or around the crusher, applying additives such as surfactants to surfaces to prevent dust from becoming airborne, and/or vacuuming.

Each type of control action can be associated with a control factor and means of computing a dilution factor, thereby allowing the prediction engine 150 to predict future PM data 155 taking into account the implementation of one or more control action. This can advantageously provide a computational simple means for the prediction engine 150 to select control actions 157, for instance by using the mathematical model to compute future PM data 155 for various hypothetical control actions 157.

In some embodiments, the prediction engine 150 is configured to implement reinforcement learning to select control actions 157. In some embodiments, the prediction engine 150 implements an RL agent, and the current data 125, 135, 145 and/or the future data 155 forecasted by the prediction engine 150 without taking control actions into consideration can be described as corresponding to the RL state. Subsequently to the prediction engine 150 selecting one or more control actions 157, e.g., based on the policy, a reward can be computed, for instance based on an absolute or relative reduction in PM concentration or emission observed in current PM data 125 and/or future PM data 155. It can be appreciated that the prediction engine 150 can implement different means of learning at least one policy, for instance one policy associated with each zone, each type of zone or each site. As examples only, the prediction engine 150 can implement Monte Carlo, Q-Learning, State-Action-Reward-State-Action (SARSA), and/or policy gradient methods. In some embodiments, Q-values are approximated by a Deep Q-Network (DQN). In some embodiments, hybrid approaches are used, combining different types of neural networks such as DQNs and CNNs.

Implementing control actions 157 can depend on system 100 including dust control equipment 160. Such equipment can include parts such as pumps, filters, pipes and compressor systems that require maintenance from time to time. In some embodiments, the system 100 further includes equipment sensors 170, attached to dust control equipment 160, and configured to assist in determining the maintenance needs 175 of said equipment 160.

Sensors 170 can for instance include vibration sensors and/or pressure sensors. As an example, vibration sensors can for instance detect changes in equipment that suggest issues like bearing wear, misalignment, or imbalances. Analyzing the frequency and amplitude of vibrations can make it possible to pinpoint specific problems, as different faults have characteristic vibration signatures. As another example, the system 100 can use machine learning algorithms to recognize vibration patterns associated with normal operation and predict failures based on deviations. For instance, a spike in vibration at a particular frequency might indicate a worn bearing. As a further example, vibration threshold alerts can be set to make it possible to alert maintenance teams when a machine's vibrations exceed safe levels, helping to schedule repairs before failures occur. As yet another example, pressure sensors can be used to monitor the health of fluid and air systems. Sudden drops or spikes in pressure may indicate leaks, blockages, or wear in pumps, seals, or hoses. This can be helpful for systems reliant on stable fluid or air pressure. As yet a further example, changes in pressure can highlight flow blockages or restrictions. For instance, if a filter is clogged, it may create a pressure drop or increase in the system, indicating the need for maintenance. As yet another example, like vibration sensors, pressure sensors can also have set thresholds to trigger alerts if the pressure goes beyond operational norms, indicating potential maintenance needs 175.

It can be appreciated that, by combining data from vibration and pressure sensors 170, it is possible to develop a holistic view of equipment health, including forecasted maintenance needs 175. In some embodiments, software is used to aggregate sensor data, trend it over time, and apply predictive analytics to estimate remaining useful life. Furthermore, when anomalies are detected in vibration and/or pressure readings, this can help narrow down the cause, as certain combinations may signal specific issues. With either or both sensor types in place, some systems can automatically generate maintenance orders or alerts, notifying technicians when they need to inspect or repair specific components. This minimizes downtime and prevents unexpected failures. Advantageously, using vibration and/or pressure data in an integrated system can provide for a shift from reactive to predictive maintenance, reducing costs and improving equipment 160 longevity.

In some embodiments, the system 100 can include additional sensors such as accelerometers and gyroscopes as means of tracking road and traffic conditions and to incorporate the road conditions and deterioration as a variable for forecasting dust emissions.

In some embodiments, the system 100 includes a dust reduction efficiency module 180 configured to compute dust reduction efficiency data 185, including for instance efficacy and/or efficiency values of different control actions 157 in different contexts. Efficacy values can include variables that reflect the ability of the control actions to reduce a concentration and/or emissions of particulate matter under certain conditions. The efficacy values can for instance include the control factors and/or the dilution factors used by the prediction engine 150. Efficiency values can include variables that reflect the efficacy of control actions in view of the resources they require, including for instance power, water and/or chemicals, in different contexts. The dust reduction efficiency data 185 can be used by the prediction engine 150 when deciding which control action(s) 157 to trigger based on data 125, 135, 145.

In some embodiments, some or all the efficacy values can be hard-coded based on past measured performances of the control actions 157. Efficacy values can for instance include the control factor. In some embodiments, the control factor reflects a rate of reduction in a particulate matter concentration and/or emissions in ideal conditions, e.g., when the control action is being or has just been implemented. Efficacy values can additionally or alternatively include a dilution factor. The dilution factor can for instance be a factor applicable to the control factor to adjust an actual efficacy value associated with a control action based on the actual conditions, e.g., the time that has passed since it was implemented, and/or, for instance in the context of mining operations, the number of vehicles that have passed and/or the quantity of material that has been processed since it was implemented. In some embodiments, the dilution factor can be 1 when there is no dilution of the effect of the control action, e.g., when it is being or has just been implemented, and can be 0 when total dilution has been attained, e.g., when the control action no longer has any particulate matter-reducing effect.

As examples only, in a mining site, in a zone corresponding to a portion of a haul road, watering provides a 70% control factor and attains total dilution after 8 hours or after 100 vehicle passes, DMS-DS Twice provides a 95% control factor and attains total dilution after 24 hours or 1920 vehicle passes, and bischofite application provides a 80% control factor and attains total dilution after 336 hours or after 18,000 vehicle passes, in a zone including a crusher, maintenance provides a 50% control factor and attains total dilution after 168 hours or after 756,000 tons of material is processed (crushed), additive application and/or fogging provides a 90% control factor and attains total dilution after 360 hours or 108,000 tons of material is processed, and vacuuming provides a 90% control factor and attains total dilution after 600 hours or after 3,024,000 tons of material is processed, and in a zone corresponding to tails storage, watering provides a 70% control factor and attains total dilution after 8 hours or after 100 vehicle passes, DMS-DS Twice provides a 95% control factor and attains total dilution after 24 hours or 1920 vehicle passes, and bischofite application provides a 80% control factor and attains total dilution after 336 hours or after 18,000 vehicle passes.

In some embodiments, dust reduction efficiency data 185 can be learned by the dust reduction efficiency module 180 based on the knowledge of past particulate matter data 125 and other past data 135, 145, and of past implemented control actions 157. This can for instance include implementing one or more symbolic regression algorithm(s) and/or implementing one or more classical machine learning training algorithms. Any suitable symbolic regression algorithm, such as a Genetic Programming algorithm and/or an AI Feynman algorithm, can be used to learn equations that can be used to compute dust reduction efficiency data 185. Additionally or alternatively, a given equation can be used, such as the exemplary equation disclosed above with respect to the prediction engine 150, and a suitable parameter estimation algorithm, such as a linear regression algorithm and/or a nonlinear optimization algorithm, can be used to learn parameters to apply to the equation based on various conditions. Additionally or alternatively, a time series forecasting model can be trained on historical data and actions to predict dust reduction efficiency data 185, for instance using linear regression, decision trees, random forests, ensemble methods such as XGBoost, support vector machines and/or neural networks, including architectures such as a MLP trained on a fixed-window input or a sequence modelling architecture, for instance a recurrent neural network (RNN), a long short-term memory (LSTM) network, a gated recurrent unit (GRU) network and/or a transformer.

In some embodiments, dust reduction efficiency data 185 include efficiency values, computed taking into account both efficacy values and resource usage, including for instance the power necessary to activate the control actions 157 and/or the resources consumed by the control actions 157, including for instance the amount of water and/or chemicals such as bischofite or other additives used. The efficiency values can be used by the prediction engine 150 to select control actions 157 that maximize an efficacy to cost ratio. As an example, when a particulate matter concentration and/or emission value exceeds a threshold by a small amount, prediction engine 150 may select watering over bischofite application if the efficacy or watering is sufficient to reduce the concentration and/or emission value to below the threshold in order to save on chemicals usage. The cost factor can include any suitable factors, including for instance the price and/or the environmental impact of the resources used by the control action.

In some embodiments, the system 100 includes a user interface such as a graphical user interface (GUI) 190 configured to enable convenient access to different types of present and/or historical data acquired or generated by the system, including for instance current particulate matter data 125, meteorological data 135, operational data 145, future particulate matter data 155, selected control actions 157, maintenance needs 175 and/or dust reduction efficiency data 185. As examples only, the GUI can be configured to display real time and/or historical, current and/or future particulate matter data 125, 155 of a zone, of a selection of zones or of a whole site, an alarm if the real-time present or future concentration of particulate matter in one or more zones of interest or the whole site is above a configurable threshold, a quantity of resources such as water and/or dust suppression products consumed in one or more zones of interest or the whole site, and/or programmed dust control activities, for instance as a list, in tabular format and/or superimposed upon a bidimensional or tridimensional map of the site, for instance a map displayed in a geographic information system. This GUI can advantageously facilitate analysis and decision making.

It can be appreciated that some components of system 100 can be characterized as internetInternet of Things devices, or more specifically as Industrial internetInternet of Things (IIoT) devices, including for instance the sensor-based devices such as the image acquisition device(s) 110, the weather station(s) 130, the operational monitoring system(s) 140 and/or the equipment sensor(s) 170. In some embodiments, the system 100 relies on an edge computing architecture, including at least one computing device acting as an edge subsystem, for instance a computing device located on the site and operatively connected to the IIoT devices and communicatively linked to a cloud subsystem. The IIoT devices can communicate with each other and/or with the edge subsystem using a variety of wired and wireless communication protocols, depending on the operational requirements such as range, power consumption, and data throughput. Wireless protocols may include Bluetooth™, Wi-Fi™, Zigbee™, LoRa™, and cellular technologies such as LTE and 5G, enabling flexible and scalable connectivity. In some embodiments, wired protocols, such as Ethernet, Modbus™, and CAN™ bus, can additionally or alternatively be used for high-speed, reliable data exchange in environments requiring reduced latency and electromagnetic interference. In some embodiments, encryption mechanisms such as TLS or AES are employed to ensure data security. In some embodiments, authentication protocols such as OAuth™ or device certificates are additionally or alternatively used to increase data security. In some embodiments, network segmentation, firewalls, and intrusion detection systems can be integrated to prevent unauthorized access and mitigate cybersecurity risks.

In some embodiments, the edge subsystem is configured for running one or some of the modules described above, including for instance the image processing engine 120 and/or the prediction engine 150, based at least in part on data received from the IIoT devices. In some embodiments, the cloud subsystem is configured to train at least some of the machine learning models described above and transmit the trained models to the edge subsystem for fine-tuning and/or execution. It can be appreciated that other types of architectures, such as alternative methods of distributing tasks between the different devices and/or systems, are also possible and can be tailored to meet specific needs. For example, in some cases, additional processing may be performed at the edge to reduce latency, while in others, more tasks could be offloaded to the cloud for scalability and data aggregation. Additionally, the balance of data storage, analytics, and decision-making between the edge and cloud subsystems can vary depending on factors like network constraints, security or confidentiality considerations, and the required speed of response. In some embodiments, the behaviour of system 100 can change depending on whether a network link is available or on the reliability of the network link. As an example, in the present of a reliable network link, some processing tasks such as running the image processing engine 120 and/or the prediction engine 150 can be outsourced to a centralized and/or distant server, whereas in the absence of such a link, all the processing can be handled locally, e.g., at edge gateways.

It can be appreciated that system 100 can be seamlessly integrated into any industrial environment, ensuring compatibility with a wide range of operational contexts and technological infrastructures. Its modular architecture and adherence to industry-standard protocols enable interoperability with existing infrastructures, whether they involve legacy systems, modern platforms, or a combination of both. This compatibility minimizes the need for extensive modifications or upgrades to pre-existing systems, reducing deployment time and costs. By supporting diverse communication standards and interfaces, the system can interact with a variety of devices, networks, and data platforms, facilitating smooth integration into complex environments. Additionally, its scalability and flexibility allow it to adapt to evolving requirements, making it suitable for dynamic and heterogeneous operational landscapes. This broad interoperability ensures that system 100 can be deployed with minimal disruption while maximizing its utility across different industries and use cases.

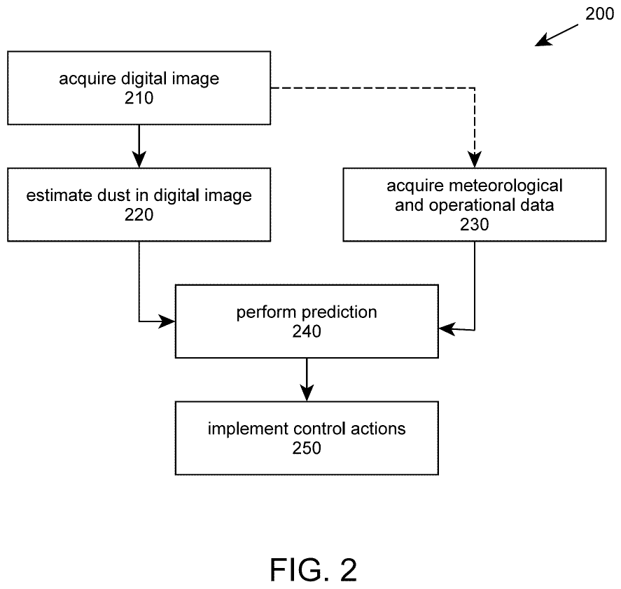

With reference to FIG. 2, an exemplary method 200 to monitor and control dust emissions in a site is shown. An initial step 210 of method 200 can include acquiring a digital image of a zone of the site, for instance via one of the imaging sensors described above. The digital image can be used in a subsequent step 220 to estimate the level of dust visible in the image, for instance by using a trained model such as a U-Net to generate a dust mask corresponding to pixels where a concentration of dust above a certain threshold is estimated to be visible and, in some embodiments, computing an absolute or relative dust level based on a proportion of pixels included in the mask. In step 230, meteorological and operational data can be acquired, for by using trained models such as CNNs to extract or estimate the data from the image acquired in step 210, and/or by using independent systems such as a weather station, a weather satellite and/or an operational monitoring system. The dust data predicted in step 220 and the meteorological and/or operational data acquired or predicted in step 230 can be used to perform predictions in a subsequent step 240, including for instance forecasting future dust levels, based for instance on a mathematical model and/or on a trained machine learning model such as a MLP. Based on the forecasted future dust levels, a final step 250 can include selecting and implementing control actions selected to lower the dust level to below a certain threshold. The action selection can for instance be based on rules applied to the future dust level and known efficacy and efficiency values of different possible control actions, and/or on trained models such as RL or hybrid RL-neural models.

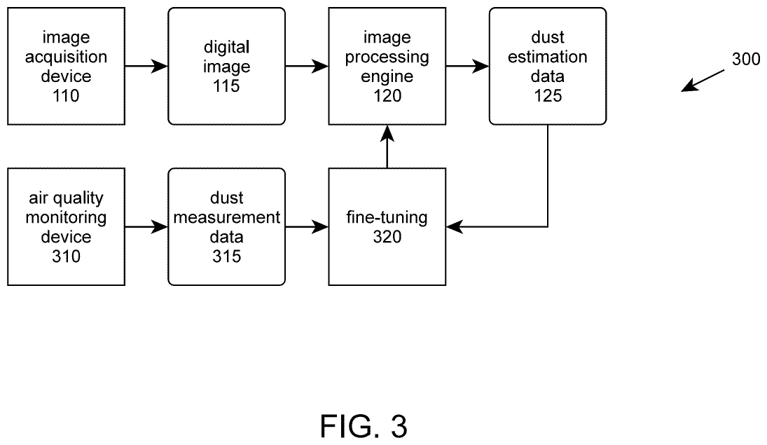

With reference to FIG. 3, an exemplary system 300 for fine-tuning the model of the image processing engine 120 is shown. Broadly described, the system 300 includes the image acquisition device 110, the image processing engine 120 including a pre-trained model, an air quality monitoring system 310 and a fine-tuning module 320 configured to fine-tune the pre-trained model.

As explained above, the image processing engine 120 includes a neural network, for instance a U-Net trained to generate a dust mask and/or a dust map based on an input image using a dataset of relatively more generic images taken at various zones or various sites and each annotated with a ground truth dust mask and/or dust map. As an example, a U-Net model used for binary segmentation of dust emissions from unsealed roads can be trained using a benchmark dataset of a suitable size, e.g., approximately 7,000 annotated images. The dataset can be generated from field experiments capturing images of vehicle-induced dust clouds on a number of unsealed road segments. Images can be manually annotated to create segmentation masks. The U-Net architecture can be trained for instance using images of 256×256 pixels and a batch size of 4 over 500 epochs, i.e., applying mini-batch gradient descent for every batch of 4 training images and repeating the training until all training images have been processed 500 times, though alternative input resolutions, batch sizes, and epoch counts could be employed depending on computational resources and desired model precision. Metrics such as the Dice Similarity Coefficient

$$\frac{2 \cdot \vert X ∩ Y \vert}{\vert X \vert + \vert Y \vert}$$

can be used to define a loss function, e.g.,

$$1 - \frac{2 {\sum }_{i} {\hat{y}}_{i} {y}_{i}}{{\sum }_{i} {\hat{y}}_{i} + {\sum }_{i} {y}_{i}} ,$$

where ŷᵢ is the predicted value for a pixel i and yᵢ is the ground truth value for i.

It can be appreciated that the model is initially trained using images from specific industrial sites, e.g., with distinct soil compositions, such as clay-rich, sandy, and gravel-based soils. However, when applying the model to images from a different, specific site—one not necessarily included in the training data—these variations in, e.g., soil composition could affect the network's accuracy, thus justifying the need for fine-tuning using a fine-tuning system such as system 300 to adapt to the unique surface textures and conditions of the new site before the system 100 of FIG. 1A is used in production. Fine-tuning allows for the optimization of the model's performance by adjusting it to better align with images of the actual site and/or zones to be monitored, improving accuracy and efficiency. Compared to training with new images, fine-tuning requires less computational resources and time, as it leverages pre-existing knowledge from the base model, while training from scratch involves learning from the ground up, often requiring larger datasets and more extensive computational power. In some embodiments, fine-tuning can additionally or alternatively be performed periodically as part of periodic system calibration.

System 300 includes an image acquisition device 110 with substantially similar characteristics as the image acquisition device 110 of system 100 in FIG. 1A discussed above. In some embodiments, the image acquisition device 110 of system 300 is the same as the image acquisition device of system 100. Image acquisition device 110 is configured to acquire digital images of a zone in the site which can be used by the image processing engine 120 to generate dust estimation data 125 for the zone.

System 300 also includes at least one air quality monitoring device 310 configured to acquire dust measurement data 315 for substantially the same zone as the image acquisition device 110 and substantially at the same time when image acquisition device 110 acquired an image 115. In some embodiments, the air quality monitoring device 310 is installed in the vicinity of the image acquisition device 110. Advantageously, because the air quality monitoring device(s) 310 are only used during fine-tuning and can thereafter be deployed to different zones or different sites, there is not such a strong incentive to diminish their acquisition cost. Therefore, an air quality monitoring device 310 can include sensors configured to acquire high quality dust measurement data 315, including for instance a gravimetric sampler, a laser particulate counter and/or a LiDAR system configured to measure different sizes of particulate matter, silica levels and/or other airborne pollutant levels. In some embodiments, mobile dust monitor paired with one or more position sensors such as a GPS, an accelerometer and/or a gyroscope are additionally or alternatively used to transmit dust emissions and concentrations paired with GPS coordinates, and road conditions.

The system 300 includes a fine-tuning module 320 configured to fine-tune the model of the image processing engine 120. The fine-tuning module can fine-tune the model based on the dust estimation data 125 and the dust measurement data 315, using the latter as a ground truth. Advantageously, this approach makes it possible to fine-tune the model for the actual task of predicting dust estimation data 125, rather than a different task the model may have been pre-trained for, such as the task of predicting dust masks. The fine-tuning module 320 can be configured to backpropagate the gradient of a different loss function into the model of the image processing engine 120 than the one used in pre-training, such as a mean squared error

$$\frac{1}{n} {\sum }_{i = 1}^{n} {( {y}_{i} - {\hat{y}}_{i} )}^{2}$$

or a mean absolute error

$$\frac{1}{n} {\sum }_{i = 1}^{n} \vert {y}_{i} - {\hat{y}}_{i} \vert ,$$

for instance computed based on a real-valued dust concentration ŷᵢ predicted from image i by the image processing engine 120 (out of n images being processed in the same training batch) and a real-valued dust concentration yᵢ measured in substantially the same zone at substantially the same time by the air quality monitoring device 310. It can be appreciated that backpropagating fine-tuning gradients can be performed for all of the model parameters or for certain parameters only. In some embodiments, some parameters of the pre-trained model are frozen, meaning they are retained but not updated during fine-tuning. In other embodiments, certain parameters or entire layers of the pre-trained model are removed or excluded before fine-tuning. In some embodiments, new layers may be added to the model for fine-tuning. Fine-tuning may also involve the use of specific hyperparameter tuning strategies, such as adjusting learning rates for certain layers or using transfer learning techniques to optimize performance on the new task.

In some embodiments, rather than fine-tuning the original model, the model is kept frozen, and a separate model is trained to provide guidance or additional adjustments to the original model's predictions. This can be achieved by training the auxiliary model to predict corrections and/or transformations to the outputs of the original model based on new data. In some embodiments, during inference, the frozen model generates initial predictions, which are then refined or adjusted by the auxiliary model to improve accuracy or adapt to new patterns in the data. In some embodiments, the auxiliary model has substantially the same architecture as the original model or has at least one layer generating an output having the same shape as a corresponding layer of the original model, such that the outputs of the layer of the auxiliary model and of the corresponding layer of the original model can be aggregated before being provided as input to the subsequent layer of the original and/or auxiliary model. This approach allows the system to retain the integrity of the original model while leveraging additional training to enhance performance without modifying the original model's parameters.

Advantageously, when using an edge computing system, the pre-training can be performed in the cloud and the comparatively less resource-intensive fine-tuning can be performed in the edge, ensuring that images of the site are not shared outside of the site. In some embodiments, to enable other sites to benefit from the fine-tuning without requiring access to the underlying data, federated learning controlled by a cloud-based system may be used, wherein updates to the model parameters are aggregated across multiple edge devices without transferring raw data. Alternatively, in some embodiments, the fine-tuned model may be distilled into a smaller model that replicates its behaviour, which can then be shared with other sites while minimizing the risk of exposing sensitive data. In yet other embodiments, the fine-tuned model may be deployed as a cloud-based service, allowing other sites to utilize its functionality through an API interface without direct access to the model or the underlying data. In embodiments relying on auxiliary models, the auxiliary model can also be shared with the cloud without having to share the fine-tuning data. Additionally, secure computation techniques, such as homomorphic encryption or secure multiparty computation, may be employed to facilitate the sharing of fine-tuning benefits while preserving data confidentiality.

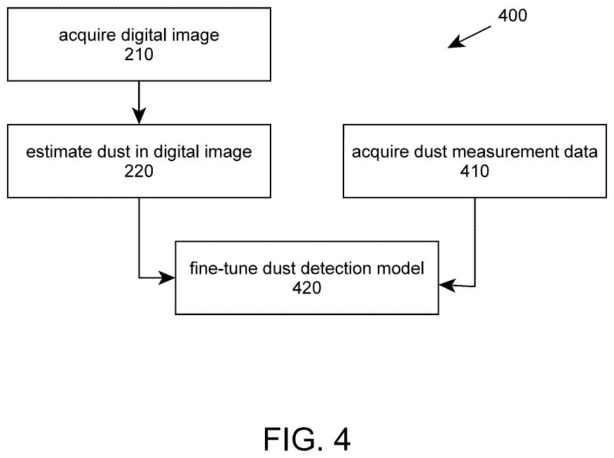

With reference to FIG. 4, an exemplary method 400 for fine-tuning a model used to estimate dust concentrations and/or emissions is shown. Initial steps of method 400 include acquiring a digital image of a zone of a site in step 210 and acquiring dust measurement data of substantially the same zone at substantially the same time in step 410. The image acquired in step 210 is used in subsequent step 220 to estimate a dust concentration and/or emission level based on a pre-trained model. The predictions of the pre-trained model and the actual measurements are compared in step 420 to fine-tune the model, e.g., by optimizing its parameters based on a loss function applied to two real-valued dust concentrations and/or emissions.

The systems and methods described above offer significant benefits in terms of precision, operational efficiency and environmental sustainability. In particular, evaluations have established that dust levels forecasts performed as described above are accurate with a precision of about 95%, allowing for a dependable prediction of critical dust levels or events. Thanks to their advanced monitoring and real-time correction actions capabilities, the methods and systems disclosed herein can make it possible to diminish unplanned downtime in the order of 30-70% as well as dust control associated CO₂ emissions by 50-80%, thereby improving operational continuity. Furthermore, the optimization of industrial processes can result in a productivity increase that can amount to up to 20-40%. Ultimately, the disclosed methods and systems can achieve reduction in dust levels, including for instance reductions in levels of PM10 between 95% and 99%, thereby contributing to a better air quality and an improved adhesion to environmental regulations.

One or more systems, methods, modules, steps or functionalities described herein may be implemented in computer programs executed on one or more processing devices, each comprising at least one processor, a data storage system (including both volatile and/or non-volatile memory and/or storage elements), and optionally at least one input and/or output device. These processing devices encompass a broad range of electronic systems capable of receiving, processing, and/or transmitting data. Examples of processing devices include, without limitation, general-purpose computers, specialized computing devices, and embedded systems. Processing devices may be implemented on dedicated hardware, including programmable hardware such as field-programmable gate arrays (FPGAs), or as software-based solutions on cloud computing platforms or serverless architectures.

Processing devices suitable for implementing the present invention may include programmable logic units, mainframe computers, servers, personal computers, laptops, cloud-based systems, personal digital assistants (PDAs), cellular telephones, smartphones, wearable devices, tablets, video game consoles, and portable video game devices. Each of these devices has the ability to execute instructions and can operate individually or in combination to perform the functionality described. The processing devices may be deployed in a variety of configurations, from single-device implementations to distributed systems that involve multiple devices collaborating to achieve a common purpose. For example, a method could be implemented on a single microcontroller in an embedded system, or distributed across a network of servers that share computational tasks.

The instructions that enable a processing device to perform a given method or function can be stored in the form of a computer program. This computer program may be implemented in a high-level programming language, such as an imperative language, including procedural or object-oriented languages like C++, Java, or Python, which are suited for a wide range of applications and can easily interface with various system components. High-level programming languages can also include declarative languages, such as functional languages like Haskell or logic languages like Prolog, which allow developers to specify what the program should accomplish rather than describing step-by-step operations. These high-level languages can improve development efficiency and code readability.

Alternatively, computer programs may be implemented in low-level languages, such as assembly or machine code, especially when direct hardware control or optimization is required. Low-level languages are closer to machine instructions and provide precise control over hardware resources, which can be advantageous in resource-constrained environments, such as embedded systems. Programs written in low-level languages can be used in applications that require high performance, small memory footprints, or real-time processing capabilities.

Each computer program may be either compiled or interpreted. Compiled languages, such as C or C++, can be transformed into machine code optimized for a specific hardware configuration, allowing efficient execution. Compilation can result in highly optimized executables that are tailored to the underlying architecture, which is advantageous in performance-critical applications. Interpreted languages, such as Python or JavaScript, offer flexibility by interpreting code at runtime. This allows for rapid development and platform independence, as the same code can be run on different systems with minimal modifications. Hybrid approaches, such as Java bytecode or .NET Common Intermediate Language (CIL), combine elements of both compiled and interpreted paradigms. In these cases, code is compiled to an intermediate representation that can be executed by a virtual machine on various platforms, providing cross-platform compatibility.

Each computer program implementing the methods or systems described herein is preferably stored on a computer-readable storage medium or device. Examples of such storage media include hard drives, solid-state drives, optical disks, flash memory, and magnetic tape. The computer-readable storage medium is readable by a general or special-purpose programmable computer, which, upon reading the instructions, can configure itself to perform the steps described herein. These instructions may include executable code, scripts, or markup that instructs the computer on how to operate and handle data, making the system or method functional. In some embodiments, the system or method may be embedded within an operating system running on a programmable computer, allowing for deeper integration with the hardware and enabling enhanced performance, security, or user interface features.

Processing devices implementing the present invention may contain a variety of hardware components that support program execution. Processors used within these devices include general-purpose central processing units (CPUs), which are capable of executing a wide variety of instructions, as well as specialized processors. Examples of specialized processors include graphics processing units (GPUs), which can be optimized for parallel processing and/or used in data-intensive applications like machine learning, digital signal processors (DSPs), which are designed for handling real-time audio, video, and other signal processing tasks, and application-specific integrated circuits (ASICs), which are tailored to specific functions and are often used in applications requiring high efficiency. Multi-core and/or multithreaded processors can allow for concurrent execution of multiple tasks, improving overall performance, for instance in multi-user or real-time environments.

The processing device may further include various types of memory. Volatile memory, such as registers, cache, and random-access memory (RAM), can be used for temporary data storage during active program execution, providing fast access to data that the processor frequently uses. Non-volatile memory, such as read-only memory (ROM), flash memory, solid-state drives, hard disks, and optical disks, can be used to retain data even when the processing device is powered off, making it suitable for long-term data storage. Other examples of non-volatile storage media include diskettes, magnetic tapes, chips, and compact disks, among others. The type of memory selected can depend on specific requirements, such as the need for rapid access, data retention, or data durability under power cycling. The memory configuration of a processing device can be adjusted to support varying levels of computational demand, from lightweight applications with minimal memory requirements to complex systems requiring large data caches.

Networking solutions within a processing device enable inter-process communication and network communication over wired or wireless connections. Examples of networking technologies include Ethernet for high-speed wired connections, Wi-Fi for wireless data transmission, Bluetooth for short-range device communication, and cellular networks for broader geographic coverage. These networking solutions support various network topologies, including local area networks (LAN), wide area networks (WAN), and other network types such as personal area networks (PAN) and metropolitan area networks (MAN), as well as the internet. Through these networks, processing devices can communicate with one another to distribute tasks, share data, and collaborate on complex computations. This communication can occur within a single building or across geographically dispersed locations, depending on the application requirements.

Implementing networking security measures can be advantageous to protect data as it travels across potentially vulnerable channels. Key security principles can include confidentiality, integrity, and availability. Confidentiality can be achieved for instance through encryption protocols like Secure Sockets Layer (SSL) and Transport Layer Security (TLS), ensuring that data remains private. Integrity can be maintained for instance with cryptographic hashing and/or digital signatures, which can detect tampering, while availability can be protected for instance by redundancy, load balancing, and defences against denial-of-service (DoS) attacks. Access control mechanisms, including multifactor authentication and role-based access control, can be used to regulate network access. Network segmentation, such as virtual LANs (VLANs) and demilitarized zones (DMZs), can be implemented to limit access to sensitive areas and reduces the impact of breaches, while firewalls filter traffic based on predefined rules, providing an essential barrier between internal and external networks.

Advanced security measures for networking can be implemented, for instance, including encryption for wireless networks through protocols like Wi-Fi Protected Access 3 (WPA3), which can prevent unauthorized access to Wi-Fi. Intrusion detection and prevention systems (IDS/IPS) can be used to monitor network traffic for malicious activity, while virtual private networks (VPNs) can be used to establish secure connections for remote access over public networks. Regular security assessments, such as penetration testing and vulnerability scanning, identify weaknesses, and security information and event management (SIEM) systems may be leveraged to provide real-time insights into potential threats. A layered security approach, or defence in depth, can combine multiple controls across different levels of the network, enhancing resilience against both internal and external attacks by creating multiple barriers that attackers must overcome.

Distributed computing is a possible implementation in which multiple processing devices work together to perform tasks described herein. For example, a method or a method step may execute within a single thread on one processing device or be distributed across multiple threads, cores, or processors on a single device or across multiple devices. Distributed computing can help implement parallelization, where tasks are split into smaller subtasks that are processed concurrently, significantly improving processing speed and efficiency. This approach is well suited to applications with high computational demands, such as data analysis, machine learning, and large-scale simulations. In some implementations, processors are located within a single physical location, while in others, they may be spread across multiple sites, allowing for redundant and resilient computing infrastructures.

Distributed computing can also be implemented within a cloud computing environment, offering flexibility and scalability. Cloud computing architectures enable the allocation of computational resources on demand, allowing tasks to utilize as many or as few resources as needed for efficient execution. For instance, a single computational process may span multiple virtual machines, distributed across data centres in different geographical locations, to achieve optimal performance and fault tolerance. By leveraging multi-tenant architectures and dynamic scaling, cloud platforms allocate resources only as needed, reducing idle computational power. Furthermore, this approach facilitates cost efficiency, as users pay only for the resources they consume. Additionally, cloud computing's ability to pool resources across large-scale infrastructure provides inherent redundancy and resilience, ensuring high availability for critical applications. Cloud computing can include employing containers and microservices to enhance resource efficiency and streamline deployment. Containers encapsulate applications and their dependencies in lightweight, portable units that can run consistently across different environments. This allows distributed computing tasks to be executed reliably across heterogeneous systems, reducing compatibility issues. Microservices architectures further divide applications into smaller, independently deployable services, each responsible for a specific functionality. These services can scale independently, ensuring that resources are allocated precisely where needed and minimizing waste. Together, containers and microservices enable more efficient use of computational resources, shorter deployment cycles, and improved fault isolation.

The systems and methods described herein can be distributed using edge computing architectures. Edge computing can introduce additional layers to distributed and cloud computing by bringing certain processing capabilities closer to data sources, such as sensors or devices in the industrial internetInternet of Things (IIoT). In this architecture, certain computational tasks can be offloaded to edge devices, such as gateways or local servers, reducing latency and minimizing the volume of data transmitted to centralized data centres. This approach can be particularly advantageous in IIoT applications where real-time decision-making can be critical, such as predictive maintenance, autonomous control systems, or industrial automation. By processing data locally, edge computing can reduce bandwidth requirements, enhance data privacy, and ensure continuity of operations even when connectivity to the cloud is intermittent. This integration of edge and cloud computing can allow organizations to benefit from both localized processing and the scalability of centralized resources.

The systems and methods described herein may also be distributed in one or more computer program products, each including a computer-readable medium that bears computer-usable instructions for one or more processors. These instructions can exist in various forms, including compiled and non-compiled code, providing the flexibility needed for deployment in diverse computing environments. For example, compiled binaries may be optimized for specific hardware, while interpreted scripts or markup files can be deployed in environments where cross-platform compatibility or rapid updates are needed.

The storage and retrieval of data in a computer system may involve various data storage solutions, including relational databases, which store data in structured tables with defined relationships, and NoSQL databases, which offer more flexible storage schemas suited to unstructured or semi-structured data. In-memory databases, which store data entirely in RAM for rapid access, can also be used in applications where low latency is desirable. These data storage solutions may be implemented on local servers, within distributed storage systems, or as part of cloud-based infrastructures, offering scalability and accessibility as required by the application. Distributed storage solutions can enable high availability and fault tolerance, ensuring that data remains accessible even if one part of the storage infrastructure fails.

Input and output devices connected to the processing device can facilitate interaction with users and other systems. Input devices can include standard peripherals, such as keyboards, mice, touchscreens, and microphones, as well as specialized input devices, such as biometric scanners, cameras, and sensors for capturing environmental data. Output devices may encompass monitors, printers, speakers, projectors, and other display systems that present information to users in various formats. These input and output devices enable users to interact with the system in intuitive ways, supporting diverse functionalities from user control of applications to data visualization and multimedia output.

The systems and methods described herein are thus capable of deployment across a broad spectrum of computing environments, supporting applications from simple embedded systems to large-scale distributed computing networks. Each component and approach described herein contributes to the versatility and adaptability of the invention, making it suitable for a wide variety of practical implementations across industries and use cases.

The disclosed neural network implementations may be realized through various configurations of computer hardware, software, or a combination of both, depending on the requirements and constraints of the particular application. For instance, the neural networks may leverage specialized hardware, such as GPUs, tensor processing units (TPUs), FPGAs, and ASICs, which are designed to efficiently handle the high computational demands of training and deploying neural networks. These hardware components are particularly advantageous for accelerating matrix operations, which are central to neural network computations, and can significantly reduce the time needed for training large models and performing inference tasks.

Alternatively, neural networks can be implemented using traditional computer hardware, including CPUs, which are versatile and widely available. While CPUs are not optimized specifically for neural network computations, they can still handle smaller models and less computationally intensive tasks effectively. In cases where flexibility is essential, such as in general-purpose computing environments, implementing neural networks on CPUs allows for integration with other software systems without the need for specialized hardware.

On the software side, neural networks can be created using various programming languages and frameworks. High-level languages such as Python, Java, and C++ are commonly used for neural network development, particularly in conjunction with deep learning libraries and frameworks like TensorFlow, PyTorch, Keras, and Theano. These frameworks provide prebuilt functions, modules, and tools that simplify the process of designing, training, and deploying neural networks. They allow developers to define network architectures, optimize training parameters, and manage data flows with relative ease. For instance, TensorFlow and PyTorch offer extensive support for GPU and TPU integration, enabling seamless transitions between hardware and software environments.

Neural networks implemented in software may also vary based on the type of language and runtime environment used. For example, imperative languages such as Python and Java allow developers to create neural networks using clear, step-by-step procedural code, making the design process intuitive and manageable. Alternatively, functional languages like Lisp and Haskell may also be employed to build neural networks, particularly when focusing on functional aspects of data flow and transformation. Moreover, neural networks can be implemented in either compiled or interpreted languages, where compiled languages, such as C++ or Java, can offer improved execution speed, while interpreted languages like Python provide flexibility and ease of development.

In certain configurations, neural networks may be deployed in distributed computing environments, allowing for parallel processing across multiple processing units or even across different geographic locations. Distributed implementations can be achieved through cloud computing platforms or high-performance computing (HPC) systems, where workloads are split among numerous machines to improve efficiency and scalability. This is particularly useful for training large-scale models that require significant processing power and storage capacity. Distributed computing frameworks such as Apache Spark and Horovod can facilitate the parallelization of neural network computations, enabling large datasets and complex models to be processed in a fraction of the time that would be required on a single machine.

Neural network implementations may also employ hybrid configurations that combine both hardware and software elements. For example, the core neural network computations might be performed on dedicated hardware accelerators like GPUs or TPUs, while the overall system, including data preprocessing and post-processing steps, can be managed by general-purpose software running on CPUs. This hybrid approach optimizes performance by leveraging the strengths of both hardware and software environments, ensuring efficient resource utilization across different components of the system.

Furthermore, it is understood that the neural networks described herein are not limited to any specific type of architecture. Various neural network architectures, including but not limited to convolutional neural networks (CNNs), recurrent neural networks (RNNs), long short-term memory (LSTM) networks, transformers, and generative adversarial networks (GANs), may be implemented depending on the task requirements. These architectures can be tailored to perform tasks such as image recognition, natural language processing, and predictive modelling, each benefiting from different configurations of hardware and software resources to optimize performance.

For secure and reliable deployment, neural networks may also incorporate mechanisms for data integrity, confidentiality, and robustness against adversarial attacks. Security protocols, such as data encryption and access control, may be applied to safeguard sensitive data processed by the neural network. Techniques like differential privacy and secure multiparty computation can be employed to protect data confidentiality during training and inference. Additionally, the implementation may include error-handling mechanisms and redundancy measures to ensure robust operation, even in environments where hardware failures or software bugs may occur.

Overall, the neural networks in this disclosure may be implemented as flexible, scalable systems that leverage combinations of hardware and software elements tailored to the needs of specific applications. This approach provides versatility, allowing the neural networks to be deployed in a wide range of environments, from dedicated hardware systems to virtualized cloud platforms, thereby supporting a diverse set of use cases and performance requirements.

In this disclosure, unless the context explicitly requires otherwise, the term “comprise” and its variations, such as “comprises” and “comprising,” are intended to be interpreted in an inclusive manner. This means that the presence of specified features or elements does not exclude the possibility of additional features, elements, or steps being included in various embodiments.

Any reference to prior art publications within this disclosure should not be taken as an acknowledgment or admission that these publications form part of the common general knowledge in the relevant field, whether in any particular jurisdiction or globally.

The examples provided in the above description serve to illustrate specific embodiments and convey certain features and principles. However, those skilled in the art will recognize that individual features, elements, and functionalities within the disclosed embodiments may be adapted, modified, or combined in numerous ways without departing from the core spirit or intended scope of the described subject matter. Therefore, the foregoing description is meant to be illustrative rather than limiting, with the scope being defined by the appended claims, which are intended to encompass all variations and modifications within the broadest interpretation permitted by applicable law.

1. A system for monitoring and controlling dust emissions in a site, comprising:
an image acquisition device configured to acquire an image of a zone of the site and image metadata;
an image processing engine comprising a neural network model trained to accept an image of the zone as input and generate a segmentation mask as output, the processing engine being configured to estimate current particulate matter data in the zone, comprising a current concentration of particulate matter, a current concentration range of particulate matter and/or a current activity emission factor in the zone, based on the segmentation mask;
a weather station and/or a weather satellite configured to measure meteorological data, and/or a weather prediction model configured to predict the meteorological data based on the image;
an operational monitoring system configured to acquire operational data and/or an operational prediction model configured to predict the operational data based on the image; and
a prediction engine configured to forecast future particulate matter data, comprising a future concentration of particulate matter, a future concentration range of particulate matter and/or a future activity emission factor in the zone, based on the current particulate matter data, the meteorological data and the operational data.

2. The system of claim 1, wherein the neural network is fine-tuned for the zone and/or for the site using a fine-tuning system comprising:
at least one air quality monitoring device installed in a vicinity of the image acquisition device and configured to acquire dust measurement data and/or at least one mobile dust monitor each paired with at least one position sensor; and
a fine-tuning module configured to compare particulate matter data estimations generated by the image processing engine based on fine-tuning images acquired by the image acquisition device and the dust measurement data and to optimize parameters of the neural network based on the comparison.

3. The system of claim 1, wherein the prediction engine is configured to forecast the future particulate matter data by aggregating, for each respective parameter of a plurality of parameters selected based on a type of the zone and/or of the site, a quotient of a baseline value of the respective parameter and of a forecast value of the respective parameter.

4. The system of claim 1, wherein the prediction engine is configured to forecast the future particulate matter data based additionally on a precipitation factor.

5. The system of claim 1, wherein the prediction engine is configured to:
cause an implementation of a control action; and
forecast the future particulate matter data based additionally on the control action.

6. The system of claim 1, further comprising additional image acquisition devices configured to acquire images of additional zones of the site and additional image metadata, wherein the image processing engine is further configured to estimate additional particulate matter data of the site, comprising additional current concentrations, additional current concentration ranges and/or additional current activity emission factors of particulate matter in the additional zones, and the prediction engine is further configured to forecast additional future particulate matter data of the site, comprising additional future concentrations, additional future concentration ranges and/or additional future activity emission factors of particulate matter in the additional zones.

7. The system of claim 6, wherein the prediction engine is further configured to optimize at least one watering route, a dry fog system activation and/or intensification, at least one dust collector activation and/or at least one water cannon activation.

8. A method for monitoring and controlling dust emissions in a site, comprising:
acquiring an image of a zone of the site and image metadata by an image acquisition device;
estimating, by a neural network model trained to accept an image of the zone as input and generate a segmentation mask as output, current particulate matter data in the zone, comprising a current concentration of particulate matter, a current concentration range of particulate matter and/or a current activity emission factor in the zone, based on the segmentation mask;
measuring or predicting based on the image meteorological data;
acquiring or predicting based on the image operational data; and
forecasting future particulate matter data, comprising a future concentration of particulate matter, a future concentration range of particulate matter and/or a future activity emission factor in the zone, based on the current particulate matter data, the meteorological data and the operational data.

9. The method of claim 8, wherein the neural network is fine-tuned for the zone and/or for the site, the fine-tuning comprising:
acquiring dust measurement data by at least one air quality monitoring device installed in a vicinity of the image acquisition device and/or at least one mobile dust monitor each paired with at least one position sensor; and
comparing particulate matter data estimations generated by the image processing engine based on fine-tuning images acquired by the image acquisition device and the dust measurement data and to optimize parameters of the neural network based on the comparison.

10. The method of claim 8, wherein forecasting the future particulate matter data comprises aggregating, for each respective parameter of a plurality of parameters selected based on a type of the zone and/or of the site, a quotient of a baseline value of the respective parameter and of a forecast value of the respective parameter.

11. The method of claim 8, wherein forecasting the future particulate matter data is based additionally on a precipitation factor.

12. The method of any claim 8, further comprising implementing a control action, wherein forecasting the future particulate matter data is based additionally on the control action.

13. The method of any claim 8, further comprising:
acquiring images of additional zones of the site and additional image metadata by additional image acquisition devices;
estimating additional particulate matter data of the site, comprising additional current concentrations, additional current concentration ranges and/or additional current activity emission factors of particulate matter in the additional zones; and
forecasting additional future particulate matter data of the site, comprising additional future concentrations, additional future concentration ranges and/or additional future activity emission factors of particulate matter in the additional zones.

14. The method of claim 13, further comprising optimizing at least one watering route, a dry fog system activation and/or intensification, at least one dust collector activation and/or at least one water cannon activation.

15. A non-transitory computer-readable medium having instructions stored thereon which, when executed by one or more processors, cause the one or more processors to:
acquire an image of a zone of the site and image metadata via an image acquisition device;
estimate, by a neural network model trained to accept an image of the zone as input and generate a segmentation mask as output, current particulate matter data in the zone, comprising a current concentration of particulate matter, a current concentration range of particulate matter and/or a current activity emission factor in the zone, based on the segmentation mask;
measure or predict based on the image meteorological data;
acquire or predicting based on the image operational data; and
forecast future particulate matter data, comprising a future concentration of particulate matter, a future concentration range of particulate matter and/or a future activity emission factor in the zone, based on the current particulate matter data, the meteorological data and the operational data.

16. The non-transitory computer-readable medium of claim 15, wherein the neural network is fine-tuned for the zone and/or for the site, the fine-tuning comprising:
acquiring dust measurement data via at least one air quality monitoring device installed in a vicinity of the image acquisition device and/or at least one mobile dust monitor each paired with at least one position sensor; and
comparing particulate matter data estimations generated by the image processing engine based on fine-tuning images acquired by the image acquisition device and the dust measurement data and to optimize parameters of the neural network based on the comparison.

17. The non-transitory computer-readable medium of claim 15, wherein forecasting the future particulate matter data comprises aggregating, for each respective parameter of a plurality of parameters selected based on a type of the zone and/or of the site, a quotient of a baseline value of the respective parameter and of a forecast value of the respective parameter.

18. The non-transitory computer-readable medium of claim 15, the instructions further causing the one or more processors to implement a control action, wherein forecasting the future particulate matter data is based additionally on the control action.

19. The non-transitory computer-readable medium of claim 15, the instructions further causing the one or more processors to:
acquire images of additional zones of the site and additional image metadata by additional image acquisition devices;
estimate additional particulate matter data of the site, comprising additional current concentrations, additional current concentration ranges and/or additional current activity emission factors of particulate matter in the additional zones; and
forecast additional future particulate matter data of the site, comprising additional future concentrations, additional future concentration ranges and/or additional future activity emission factors of particulate matter in the additional zones.

20. The non-transitory computer-readable medium of claim 19, the instructions further causing the one or more processors to optimize at least one watering route, a dry fog system activation and/or intensification, at least one dust collector activation and/or at least one water cannon activation.
